(19) United States
(12) Patent Application Publication
(10) Pub. No.: US 2021/0319767 A1
(43) Pub. Date: Oct. 14, 2021

(54) ACTIVATION OF A PORTION OF A DISPLAY OF A COMPUTING DEVICE

(71) Applicant: Micron Technology, Inc., Boise, ID (US)

(72) Inventor: Carla L. Christensen, Boise, ID (US)

(21) Appl. No.: 16/843,586

(22) Filed: Apr. 8, 2020

(51) Int. Cl. G09G 5/14; G06F 3/0488

(52) U.S. Cl. CPC G09G 5/14; G09G 2354/00; G06F 3/04883

(57) ABSTRACT

Methods, apparatuses, and non-transitory machine-readable media activation of a portion of a display of a computing device are described. Apparatuses can include a display, a memory device, and a controller. In an example, a method can include the controller receiving a request to illuminate a portion of the display, and in response, activating the portion of the display while a remaining portion of the display remains inactive. In another example, the controller can receive a request to inactivate a portion of a touchscreen display of a computing device and inactivate the portion responsive to the request while a remaining portion of the touchscreen display remains inactive.

### TECHNICAL FIELD

The present disclosure relates to apparatuses, non-transitory machine-readable media, and methods for activation of a portion of a display of a computing device.

### BACKGROUND

A computing device is a mechanical or electrical device that transmits or modifies energy to perform or assist in the performance of human tasks. Examples include thin clients, personal computers, printing devices, laptops, mobile devices (e.g., e-readers, tablets, smartphones, etc.), internet-of-things (IoT) enabled devices, and gaming consoles, among others. An IoT enabled device can refer to a device embedded with electronics, software, sensors, actuators, and/or network connectivity which enable such devices to connect to a network and/or exchange data. Examples of IoT enabled devices include mobile phones, smartphones, tablets, phablets, computing devices, implantable devices, vehicles, home appliances, smart home devices, monitoring devices, wearable devices, devices enabling intelligent shopping systems, among other cyber-physical systems.

A computing device can include a display used to view images or text. The display can be a touchscreen display that serves as an input device. When a touchscreen display is touched by a finger, digital pen (e.g., stylus), or other input mechanism, associated data can be received by the computing device. The touchscreen display may include pictures and/or words, among others that a user can touch to interact with the device.

### BRIEF DESCRIPTION OF THE DRAWINGS

FIG. 1 is a functional block diagram in the form of a computing system including an apparatus having a display, a memory device, and a controller in accordance with a number of embodiments of the present disclosure.

FIG. 2 is a diagram representing an example of activation of a portion of a display of a computing device in accordance with a number of embodiments of the present disclosure.

FIG. 3 is another diagram representing an example of activation of a portion of a display of a computing device in accordance with a number of embodiments of the present disclosure.

FIG. 4 is yet another diagram representing an example of activation of a portion of a display of a computing device in accordance with a number of embodiments of the present disclosure.

FIG. 5 is a functional diagram representing a processing resource in communication with a memory resource having instructions stored thereon for activation of a portion of a display of a computing device in accordance with a number of embodiments of the present disclosure.

FIG. 6 is a flow diagram representing an example method for activation of a portion of a display of a computing device in accordance with a number of embodiments of the present disclosure.

### DETAILED DESCRIPTION

Apparatuses, machine-readable media, and methods related to activation a portion of a display (e.g., a touchscreen) of a computing device are described. A computing device display may be considered “active” when it allows for interaction, particularly with respect to touchscreen displays. The interaction can include using a touch input such as a finger or digital pen to select something on the display (e.g., select a picture, select a link, zoom in or out, etc.) and sent data to the controller (e.g., a user gets a response out of the touch input). For instance, a user can touch a web address link with a digital pen, a controller can open the web address page, and the display can change to that web address page. When a user is browsing the Internet on his or her smartphone, working on a laptop, or reading on an e-reading device the display may be interactive to allow for an improved experience using particular applications. A display or portion of a display that allows for interaction and data submission to a controller may be considered “active” or “activated”, while a display or portion of a display that does not allow for interaction and data submission to a controller may be considered “inactive” or inactivated”.

An active display can be disruptive and/or undesired, for instance when a user has a child, pet, or other distraction that touches the display. For instance, a child may touch a portion of the display that the user does not want touched, for example a “buy now” button on an online retailer site or an “end call” button present during a phone call. For instance, a user reading to a child on an e-reader device may desire the page turn portion (e.g., “next page” button, arrows, swiping portion, etc.) of the display to be inactive to prevent page turns by the child before the page is read. Additionally, having an entirely active display can increase power consumption by the computing device and decrease battery life.

Some approaches to reducing unwanted input include inactivating an entire display of a computing device. However, this does not allow for interaction of any kind with the display and may require frequent activation and inactivation of the entire display. Examples of the present disclosure can ease disruption, reduce power consumption by the computing device, and increase battery life of the computing device by activating only a portion of the display designated by a user and/or determined to be an active portion of the display. For instance, examples can include a method for activating a portion of a display of a computing device including receiving signaling via a touchscreen that indicates a portion of the touchscreen to be activated and identifying a surface area bounded by the portion of the touchscreen indicated by the signaling. The method can include allowing change in a state the touchscreen is monitoring within the portion and restricting change in a state the touchscreen is monitoring outside the portion.

Other examples of the present disclosure can include an apparatus including a display, a memory device, and a controller coupled to the memory device configured to receive a request to inactivate a portion of a touchscreen display of a computing device and inactivate, responsive to the request, the portion of the touchscreen display while a remaining portion of the touchscreen display remains active. Data can be received by the controller responsive to a touch input received in the active portion, while data is not be received by the controller responsive to a touch input received in the inactive portion of the touchscreen display. As used herein, an “apparatus” can refer to, but is not limited to, any of a variety of structures or combinations of structures, such as a circuit or circuitry, a die or dice, a module or modules, a device or devices, or a system or systems, for example.

Yet other examples of the present disclosure can include a non-transitory machine-readable medium comprising a processing resource in communication with a memory resource having instructions executable by the processing resource to receive a touch request via a touchscreen display of a mobile device to activate a portion of the touchscreen display. The instructions can be executable to activate the portion of the touchscreen display while a remaining portion of the touchscreen display remains inactive.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

As used herein, designators such as “N,” etc., particularly with respect to reference numerals in the drawings, indicate that a number of the particular feature so designation can be included. It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

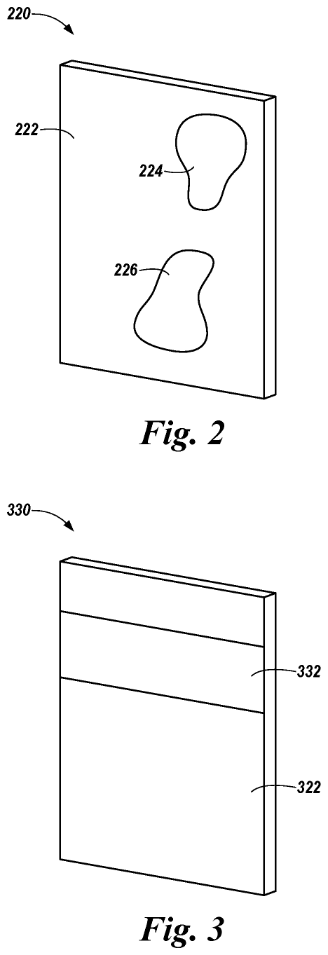

The figures herein follow a numbering convention in which the first digit or digits correspond to the figure number and the remaining digits identify an element or component in the figure. Similar elements or components between different figures can be identified by the use of similar digits. For example, 222 can reference element “22” in FIG. 2, and a similar element can be referenced as 322 in FIG. 3. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

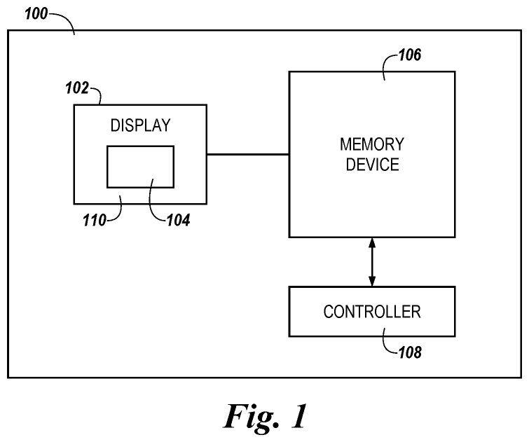

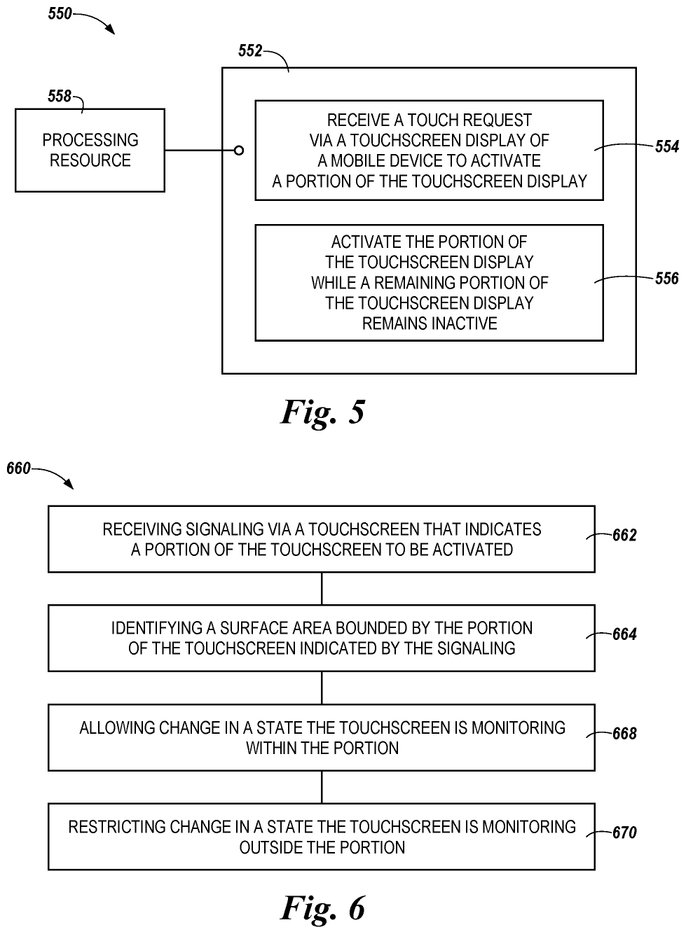

FIG. 1 is a functional block diagram in the form of a computing system including an apparatus 100 having a display 102, a memory device 106, and a controller 108 (e.g., a processor, control circuitry, hardware, firmware, and/or software) in accordance with a number of embodiments of the present disclosure. The memory device 106, in some embodiments, can include a non-transitory MRM, and/or can be analogous to the memory resource 552 described with respect to FIG. 5. The apparatus 100 can be a computing device; for instance, the display 102 may be a touchscreen display of a mobile device such as a smartphone. The controller 108 can be communicatively coupled to the memory device 106 and/or the display 102. As used herein, “communicatively coupled” can include coupled via various wired and/or wireless connections between devices such that data can be transferred in various directions between the devices. The coupling need not be a direct connection, and in some examples, can be an indirect connection.

The memory device 106 can include non-volatile or volatile memory. For example, non-volatile memory can provide persistent data by retaining stored data when not powered, and non-volatile memory types can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory (e.g., 3D XPoint™), resistive random access memory (RRAM), ferroelectric random access memory (FeRAM), magnetoresistive random access memory (MRAM), and programmable conductive memory, among other types of memory. Volatile memory can require power to maintain its data and can include random-access memory (RAM), dynamic random-access memory (DRAM), and static random access memory (SRAM), among others.

The controller 108 can receive a request to activate a portion 104 of the display 102, and can activate that portion 104, while a remaining portion 110 remains inactive. For instance, a user may select via a menu (e.g., a “settings” menu, a “display” menu, etc.) displayed on the display 102 to activate the portion 104 while leaving the portion 110 inactive. Such a menu may give the user options as to what portion of the display 102 to activate and/or the user may be able to customize a portion of the display 102 to activate. For instance, the user may choose a predefined portion of the display 102 from a list of options in a menu using a touchscreen or non-touchscreen display or may customize using a touchscreen display. For example, when the display 102 is a touchscreen display, the controller 108 can receive the request via a touch input on the touchscreen display via the menu or a manual drawing. For instance, a user can draw on the touchscreen display to indicate a size and shape of the portion 104 to be activated.

When the display 102 is a touchscreen display, the controller 108 receives data responsive to a touch input received in the active portion 104 of the display 102 but does not receive data responsive to a touch input received in the inactive portion 110 of the display 102. In some examples, the portion 104 may be activated, and/or the inactive portion 110 may be inactivated. For instance, if the entire display 102 is currently active, and a user chooses an area to remain active, the portion 110 may be inactivated. In some examples, a user can choose which portion to inactivate instead of a portion to activate.

In some instances, the controller 108 can identify a portion 104 based on a pattern created by a user or an application. The controller 108 can cause a change in a state the touchscreen (e.g., display 102) is monitoring within the portion 104 and can restrict change in a state the touchscreen is monitoring outside the portion 104 (e.g., “inactivated” portion 110). In some inactivation examples, overall power savings can be achieved.

For instance, when a user places his or her finger or a digital pen on the touchscreen, it changes the state that the computing device 100 associated with the touchscreen is monitoring. In examples in which the touchscreen relies on sound or light waves (e.g., surface acoustic wave, infrared touch, etc.), the finger or digital pen blocks or reflects some of the waves. The controller 108 can cause and/or allow the blocking or reflecting of some of the waves in the portion 104 and restrict blocking or reflecting of waves in the portion 110, for example.

In examples in which the touchscreen is capacitive (surface, projected, mutual, self, etc.) and uses a layer of capacitive material to hold an electrical charge, touching the screen changes the amount of charge at a particular point of contact. The controller 108 can cause and/or allow changes to an amount of charge in the portion 104 and restrict changes to an amount of charge in the portion 110, for example.

In examples in which the touchscreen is a resistive screen, the pressure from a finger or digital pen cause conductive and resistive layers of circuitry to touch each other, changing the circuits' resistance. While a few touchscreen examples are used herein, the touchscreen may be other types of touchscreens (infrared grid, infrared acrylic projection, optical imaging, dispersive signal technology, acoustic pulse recognition, etc.). The controller 108 can cause and/or allow changes to an amount of charge in the portion 104 and restrict blocking or reflecting of waves in the portion 110, for example.

In some instances, the memory device 106 can affect the activation of the portion 104. For example, a portion of the memory device 106 (e.g., holographic random-access memory (HRAM), 3D XPoint™, etc.) may be powered off in proportion the inactivated portion 110. In other examples, the memory device 106 (e.g., a multi-chip package (MCP)) can be leveraged to support selective activation. In yet other examples, a screen map or surface area may be stored in the memory device 106 (e.g., non-volatile memory) to facilitate activating/inactivating portions of the display 102.

For instance, the controller may receive a request to inactivate a portion 110 of display 102. A user may select via a menu (e.g., a “settings” menu, a “display” menu, etc.) displayed on the display 102 to inactivate the portion 110 while leaving the portion 104 active. Such a menu may give the user options as to what portion of the display 102 and/or the user may be able to customize a portion of the display 102 to inactivate. For instance, the user may choose a predefined portion of the display 102 from a list of options in a menu using a touchscreen or non-touchscreen display or may customize using a touchscreen display. For instance, when the display 102 is a touchscreen display, a user can draw on the touchscreen display to indicate a size and shape of the portion 110 to be inactivated. A user may be able to indicate a size and shape of the inactive portion 110 (e.g., a circle around a “buy now” button on a retail website). While particular shaped portions 104 and 110 are illustrated in FIG. 1, other shapes may be chosen and more than one portion of the display 102 may be activated (or inactivated) while remaining portions remain inactive (or active).

In some examples, while a particular portion is inactive (or active), an additional touch request may be received via a touchscreen display to inactivate (or activate) an additional portion of the touchscreen display. For instance, a user may determine he or she would like additional text, image, video, etc. inactivated. The additional portion of the touchscreen display can be inactivated while inactivation of the inactivate portion (e.g., the original inactive portion) is retained. The touch request can be in the form of a drawing on the touchscreen display or via a menu, for example.

In a non-limiting example, a parent and toddler may be video chatting with a grandparent using a tablet. The parent may desire not to have the toddler end the video session by pushing an “end call” button on the tablet. The parent can request from the controller 108 via a menu or via drawing using touch input to activate a particular portion (e.g., the portion 104) of the display, while leaving the remaining portion (e.g., the portion 110) inactive. The inactive portion may include the “end call” button, so that the toddler cannot interact with that portion of the display, but can interact with the active portion (e.g., zoom in on the grandparent, etc.). Alternatively, the parent can request from the controller 108 via a menu or via drawing using touch input to inactivate a particular portion (e.g., the portion 110) of the display, while leaving the remaining portion (e.g., the portion 104) active. The inactive portion may include the “end call” button, so that the toddler cannot interact with that portion of the display, but can interact with the active portion (e.g., zoom in on the grandparent, etc.). Whether the user is allowed to request activation or inactivation may be determined via a settings menu or other configuration, for instance.

In some examples, the controller 108 can determine a current active portion of the display 102 and based on that determination, activate (or leave active) the active portion (e.g., the portion 104), while a current inactive portion remains inactive (e.g., the portion 110) or is inactivated such that interaction with the display (e.g., submitting of data) is not allowed. For instance, if a user is watching a video on a particular portion of the display 102, the controller can activate (or leave active) that particular portion (e.g., portion 104) and inactivate the remaining portion (e.g., portion 110). As used herein, a current active portion can include a portion of the display that includes movement, and/or has experienced user interaction such as swiping or tapping within a threshold period of time, among others. A current inactive portion can include a portion of the display that does not include movement and/or has not experienced user interaction such as swiping or tapping within a threshold period of time, among others.

A non-limiting example may include a user swiping through pictures in a small window of a touchscreen display of a mobile device, while the remaining portion of the touchscreen display illustrates a default background screen of the touchscreen display. In such an example, the controller 108 can determine the portion including the pictures being viewed is a current active portion, while the remaining portion is currently inactive. In response, the controller 108 can activate the current active portion, while the current inactive portion remains inactive or is inactivated such that interaction is not allowed.

In some examples, the active or inactive portion can be a portion of the display 102 that is determined based on an application running on the apparatus 100. For instance, if a particular reading application is in use, a user may desire only a top portion of the display to be active, and they can scroll (e.g., swipe) the words through the active portion 104. For instance, in a non-limiting example, if a user is reading to a child, he or she may desire a larger portion with which the child cannot interact, but a small portion where he or she can scroll to advance text. As such, a user may request that when the particular reading application is in use, a particular portion of the display 102 is inactivated, while the remaining portion is active. This can be done without user input (e.g., upon loading the reading application the controller 108 determines the active portion 104 and/or inactive portion 110 without user prompts) or a user may select a prompt asking if this is a preference. For instance, upon loading the application, the controller 108 determines that the user may want to activate only a portion of the display 102 and may prompt the user for affirmation. Put another way, the inactive portion 110 can be a predefined portion of the display 102 determined based on the application running on the computing device.

The active portion 104 or inactive portion 110 can be determined, in some instances, based on data context in the active portion 104. The data context, as used herein, includes the text or image within a particular portion of the display 102. For instance, in a non-limiting example, the controller 108 may determine that a video is playing in a first portion of the display 102, and an advertisement is located in a second portion of the display 102. In such an example, the controller 108 can determine that the first portion is an active portion 104, and the second portion is inactive. In response, the controller can activate (or keep active) the active portion 104 and leave the inactive portion 110 inactive. This can be done without user input (e.g., upon loading the video, the controller 108 determines the active portion 104 without user prompts) or a user may select a prompt asking if this is a preference. For instance, upon loading the video, the controller 108 determines that the user may want to activate only a portion (e.g., the active video portion) of the display 102 and may prompt the user for affirmation. Put another way, the inactive portion 110 can be a predefined portion of the display 102 determined based on the data context in the active portion 104 and/or the inactive portion 110.

In non-limiting examples in which the display 102 is a touchscreen display, the controller 108 can receive a request from a user to activate (or keep active) active portions of the touchscreen display. In response to the request, the controller 108 can determine an active portion 104 or active portions of the touchscreen display and activate those portions. In another non-limiting example, the controller 108 can determine the active portion based on a location of a touch input on the touchscreen display. For instance, the controller 108 may determine multiple active portions, and a user may touch a portion of the touchscreen display to indicate which of those determined active portions he or she desires to be the active portion to be activated. There may be more than one active portion and more than one activated portion, in some examples.

FIG. 2 is a diagram representing an example of activation of a portion 224, 226 of a display 222 of a computing device 220 in accordance with a number of embodiments of the present disclosure. Computing device 220, for instance, may be a smartphone with a touchscreen display 222. A user may decide to activate portions 224 and 226 of the touchscreen display 222 by drawing a particular shape with his or her finger or a digital pen, for example. The particular shape is not limited to the shapes illustrated in FIG. 2. A portion of the touchscreen display 222 that is not activated (e.g., portions other than 224 and 226) remain inactive. For instance, the user may desire to activate only the particular portions around videos, pictures, or particular portions of a webpage, for instance. In a non-limiting example, the portions 224 and 226 are active portions that are activated (e.g., without user input) upon a controller determining the portions 224 and 226 are active. Such a determination can be based on a user deeming the portions 224 and 226 active (e.g., via a menu and/or touch input), an application in use by the computing device 220, or data context in the portions 224 and 226, among others.

Alternatively, the portions 224 and 226 may be chosen as portions to inactivate, while the remain portion of the touchscreen display 222 remain active. For instance, if the user is browsing an online retailer on a smartphone display while holding a small child, the user may choose to draw a circle around a “buy now” button, so as to prevent the small child from touching the smartphone's display and making a purchase.

By activating a portion of the display of the computing device (e.g., portions 224 and 226) instead of the entire display 222, the computing device 220 may experience an increase in battery life and/or a reduction in power consumption. In a non-limiting example, a user may choose to activate a portion of the display to increase privacy (e.g., other users cannot use touch input to access sensitive data (e.g., a banking application)). Drawing a shape to be activated (or inactivated) may be enabled on the computing device at all times or may be enabled via a menu, in some examples.

FIG. 3 is another diagram representing an example of activation of a portion 332 of a display 322 of a computing device 330 in accordance with a number of embodiments of the present disclosure. Computing device 330, for instance, may be a smartphone with a touchscreen display 322. A user may decide to activate portion 332 of the touchscreen display by selecting the portion from a menu. For instance, a user may choose the portion 332 based on options in the menu or may draw the portion 332 on the screen using a digital pen or his or her finger. The user may desire to activate only particular portions around videos, pictures, or particular portions of a webpage, for instance. The particular shape and size of the portion 332 is not limited to the shape and size illustrated in FIG. 3 and more than one portion may be selected. A portion of the touchscreen display 322 that is not activated (e.g., portions other than the portion 332) remains inactive.

In a non-limiting example, the portion 332 is activated as a result of controller determining an active status of the portion 332. In another non-limiting example, the portion 332 may be activated based on application or data context in the portion 332. For instance, the portion 332 may be deemed active based on activity in the portion 332 (e.g., scrolling book text, webpage activity, social media posts, etc.). The portion 332 may be activated without user input based on the activity or such settings may be customized, for instance, in the menu.

By activating a portion of the display of the computing device (e.g., portions 224 and 226) instead of the entire display 222, the computing device 220 may experience an increase in battery life and/or a reduction in power consumption. In a non-limiting example, a user may choose to activate a portion of the display to increase privacy (e.g., other users cannot use touch input to access sensitive data (e.g., a banking application)).

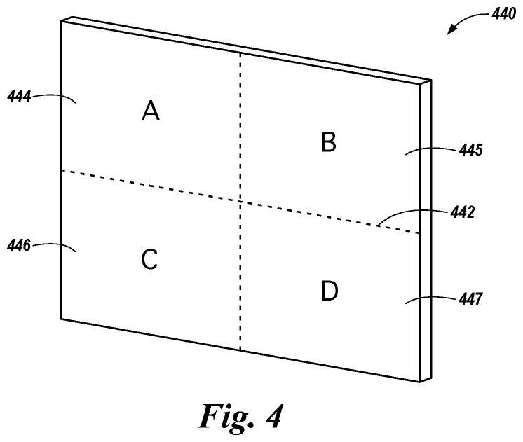

FIG. 4 is yet another diagram representing an example of activation of a portion 444, 445, 446, and/or 447 of a display 442 of a computing device 440 in accordance with a number of embodiments of the present disclosure. The display 442 is divided into four portions: portion A 444, portion B 445, portion C 446, and portion D 447. While four portions are illustrated in FIG. 4, more or fewer portions may be available. The portions 444, 445, 446, 447 may be predetermined portions such that a user can choose from these four options with respect to which portion he or she would like to activate. For instance, the display 442 split into portions 444, 445, 446, 447 may be a default setting or option on an e-reader.

In another example, the portions 444, 445, 446, 447 may be drawn by a user using a touch input such as a finger or digital pen. For instance, the user may choose to activate portion A 444 and portion B 445 of a tablet device during a video chat with a child, so that the child does not press the “end call” button located in portion C 446 and/or portion D 447. While four portions are illustrated in FIG. 4, more or fewer portions may be possible. Similar differently shaped portions may be possible.

FIG. 5 is a functional diagram representing a processing resource 558 in communication with a memory resource 552 having instructions 554, 556 stored thereon for activation of a portion of a display of a computing device in accordance with a number of embodiments of the present disclosure. The memory resource 552, in some embodiments, can be analogous to the memory device 106 described with respect to FIG. 1. The processing resource 558, in some examples, can be analogous to the controller 108 describe with respect to FIG. 1.

A system 550 can be a server or a computing device (among others) and can include the processing resource 558. The system 550 can further include the memory resource 552 (e.g., a non-transitory MRM), on which may be stored instructions, such as instructions 554 and 556. Although the following descriptions refer to a processing resource and a memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

The memory resource 552 may be electronic, magnetic, optical, or other physical storage device that stores executable instructions. Thus, the memory resource 552 may be, for example, a non-transitory MRM comprising Random Access Memory (RAM), an Electrically-Erasable Programmable ROM (EEPROM), a storage drive, an optical disc, and the like. The memory resource 552 may be disposed within a controller and/or computing device. In this example, the executable instructions 554 and 556 can be “installed” on the device. Additionally and/or alternatively, the memory resource 552 can be a portable, external or remote storage medium, for example, that allows the system 550 to download the instructions 554 and 556 from the portable/external/remote storage medium. In this situation, the executable instructions may be part of an “installation package”. As described herein, the memory resource 552 can be encoded with executable instructions for activation of a portion of a display of a computing device.

The instructions 554, when executed by a processing resource such as the processing resource 558, can include instructions to receive a touch request via a touchscreen display of a mobile device to activate a portion of the touchscreen display. For instance, a user may issue the request via a menu of the mobile device or may draw a shape directly on the touchscreen display that he or she desires to activate. The touch input received can include input via a finger or a digital pen, among other touch input approaches. In some examples, optional portions of the touchscreen display to activate can be displayed via the touchscreen display, and in response, the received touch request includes a request to activate one of the optional portions. For instance, a user may be presented with options as to which portion or portions of the display he or she would like activated, and the user can interact with the touchscreen display (e.g., touch request) to choose the desired portion or portions.

The instructions 556, when executed by a processing resource such as the processing resource 558, can include instructions to activate the portion of the touchscreen display while a remaining portion of the touchscreen display remains inactive. The activated portion can include a particular shape based on the shape of the touch request. For instance, a user may use a digital pen to draw a circle around a particular portion of a social media page he or she is viewing. The activated portion in such an example is the circle in that particular portion of the touchscreen display.

In another example, the activated portion is a predefined portion of the touchscreen display determined based on an application running on the mobile device or data context in the activate portion. For instance, when a user opens a particular application (e.g., an e-reading application), the mobile device may activate (e.g., without user input) a particular portion of the display, a user may be prompted to choose a particular portion of the display, or a user may be given the option to activate a portion or the entire display.

In a non-limiting example with respect to data context, when a video streaming service is detected, the mobile device may activate (e.g., without user input) a particular portion of the display (e.g., the video streaming portion), a user may be prompted to choose a particular portion of the display, or a user may be given the option to activate a portion or the entire display. Other application and text contexts may be bases for the activated portion.

In some examples, while the portion is activated, an additional touch request may be received via the touchscreen display to activate an additional portion of the touchscreen display. For instance, a user may determine he or she would like additional text, image, video, etc. activated. The additional portion of the touchscreen display can be activated while activation of the activated portion (e.g., the original activated portion) is retained. The touch request can be in the form of a drawing on the touchscreen display or via a menu, for example.

FIG. 6 is a flow diagram representing an example method 660 for activation of a portion of a display of a computing device in accordance with a number of embodiments of the present disclosure. The method 660 can include, for example, receiving a request to activate a portion of a display of a computing device. For instance, at 662, the method 660 includes receiving signaling via a touchscreen that indicates a portion of the touchscreen to be activated. For example, the signaling can be a user drawing a shape to activate using a finger or digital pen.

For instance, the controller may receive a request to activate a predefined portion or a custom portion of the display. In such an example, the computing device may be a mobile device with a display (e.g., an e-reader, smartphone, tablet, etc.), and the controller can receive a request to activate portion A, which a user chose from a list of predefined portions (e.g., portion A, portion B, portion C, portion D, etc. as illustrated in FIG. 4) for activation.

At 664, the method 660 can include identifying a surface area bounded by the portion of the touchscreen indicated by the signaling, and at 668 the method 660 can include allowing change in a state the touchscreen is monitoring within the portion. Allowing change in the state the touchscreen is monitoring, in some instances, can include allowing interaction with the touchscreen via touch input of the touchscreen display. For instance, this can be done responsive to receiving a request to active the portion of a display (e.g., a touchscreen display) of a computing device. That is, upon receiving the signaling, a controller may determine the surface area of the portion chosen and what change in state to allow within that surface area.

At 670, the method 660 can include restricting change in a state the touchscreen is monitoring outside the portion. For instance, upon receiving the signaling indicating the portion to be activated, a controller may determine the surface area of the portion outside of the chosen portion and what change in state to restrict within that surface area desired to remain inactive. In some examples, receiving the signaling can include receiving a request to activate a plurality of portions of the touchscreen receiving the signaling and in response, allowing changes in state to each one of the plurality of portions of the display while restricting changes in state to each one of the remaining plurality of portions of the touchscreen.

In a non-limiting example where a user is using an e-reader, he or she may desire to have half of the display activated (e.g., so as not to be disturbed by child trying to touch the display). This may comprise portions A and B of portions A, B, C, and D, for instance as illustrated in FIG. 4. The user may interact with the e-reader via the display (e.g., using buttons with a non-touchscreen display, using touch input with a touchscreen display, etc.) and choose from a menu which portions he or she would like activated. The controller receives the request upon completion of the selection.

In the same example where the user is using an e-reader, he or she may instead request a customized portion to be activated. This can be requested via a touch input such on a touchscreen display as a drawing on a touchscreen display in the desired shape and size. More than one customized portion may be requested, with the controller receiving the request upon completion of the customized request.

In another non-limiting example, a user may have on his or her phone a banking application. He or she may desire to have the touchscreen display on the smartphone active in all areas except a small portion of the display around the banking application icon (e.g., to prevent others with access the smartphone from accessing bank records (e.g., to protect privacy)), and may request only portion C of a list of predefined portions A, B, C, D, etc. be activated. The user may interact with the smartphone via the display (e.g., using buttons with a non-touchscreen display, using touch input with a touchscreen display, etc.) and choose from a menu which portions he or she would like activated. The controller receives the request upon completion of the selection.

In the same example where the user is using the smartphone, he or she may instead request a customized portion to be activated. This can be requested via a touch input on a touchscreen display such as a drawing on a touchscreen display in the desired shape and size. More than one customized portion may be requested. For instance, the user may draw a rectangular shape around the banking application icon to be inactivated while the remaining portions of the bank statements remain active. The controller receives the request upon completion of the customized request.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method, comprising:
in response to launching of a particular application on a computing device having a touchscreen and based on the particular application, providing a prompt via the touchscreen requesting a particular portion of the touchscreen to be activated;
receiving signaling in response to the prompt and via the touchscreen that indicates the particular portion of the touchscreen to be activated;
identifying a surface area bounded by the portion of the touchscreen indicated by the first signaling;
allowing change in a state the touchscreen is monitoring within the particular portion; and
restricting change in a state the touchscreen is monitoring outside the particular portion.

2. The method of claim 1, wherein receiving the signaling comprises receiving a request to activate a pre-defined portion of the touchscreen.

3. The method of claim 1, wherein the touchscreen is a display of the computing device and receiving the signaling comprises receiving a request to activate a pre-defined portion of the display of the computing device.

4. The method of claim 2, wherein the touchscreen is a display of a mobile device and receiving the request comprises receiving a request to activate a pre-defined portion of the touchscreen display.

5. The method of claim 1, wherein receiving the signaling comprises receiving a request via a touch input on the touchscreen.

6. The method of claim 5, wherein receiving the signaling comprises receiving a request to activate a particular shape drawn on the touchscreen.

7. The method of claim 1, wherein receiving the signaling comprises receiving a request to activate a plurality of particular portions of the touchscreen; and
allowing changes in state to each one of the plurality of particular portions of the display while restricting changes in state to each one of the remaining plurality of particular portions of the touchscreen.

8. The method of claim 1, wherein allowing change in the state the touchscreen is monitoring within the particular portion comprises allowing interaction with the touchscreen via touch input of the touchscreen display.

9. An apparatus, comprising:
a display;
a memory device;
a controller coupled to the memory device configured to:
in response to launching of a particular application on a computing device having a touchscreen display and based on the particular application, provide a prompt via the touchscreen display requesting a particular portion of the touchscreen to be activated;
receive a request, responsive to the prompt, to inactivate the portion of a touchscreen display of the computing device; and
inactivate, responsive to the request, the particular portion of the touchscreen display while a remaining portion of the touchscreen display remains active,
wherein data is received by the controller responsive to a touch input received in the active portion of the touchscreen display; and
wherein data is not received by the controller responsive to a touch input received in the inactive portion of the touchscreen display.

10. The apparatus of claim 9, wherein the inactive portion is a predefined portion of the touchscreen display determined based on the application running on a mobile device.

11. The apparatus of claim 9, wherein the inactive portion is a predefined portion of the touchscreen display determined based on data context in the active portion.

12. The apparatus of claim 9, further comprising the controller configured to receive the request via a touch input on the touchscreen display.

13. The apparatus of claim 9, further comprising the controller configured to inactivate an additional portion of the touchscreen display responsive to a request received via a touch input to inactivate the additional portion.

14. The apparatus of claim 9, wherein:
the received request comprises a particular shape drawn as a touch input on the touchscreen display; and
the inactive portion of the touchscreen display comprises the particular shape.

15. A non-transitory machine-readable medium comprising instructions executable by a processing resource to:
in response to launching of a particular application on a mobile device having a touchscreen display and based on the particular application, provide a prompt via the touchscreen display requesting a particular portion of the touchscreen to be activated;
receive, responsive to the prompt, a touch request via the touchscreen display of the mobile device to activate the particular portion of the touchscreen display; and
activate the particular portion of the touchscreen display while a remaining portion of the touchscreen display remains inactive.

16. The medium of claim 15, wherein the activated portion is based on a shape of the touch request.

17. The medium of claim 15, wherein the activated portion is a predefined portion of the touchscreen display determined based on the application running on the mobile device.

18. The medium of claim 15, wherein the activated portion is a predefined portion of the touchscreen display determined based on data context in the activated portion.

19. The medium of claim 15, further comprising the instructions executable to:
receive an additional touch request via the touchscreen display to activate an additional portion of the touchscreen display; and
activate the additional portion of the touchscreen display while retaining activation of the activated portion.

20. The medium of claim 15, further comprising the instructions executable to:
display via the touchscreen display, optional portions of the touchscreen display to activate,
wherein the received touch request includes a request to activate one of the optional portions.
